(19) United States
(12) Patent Application Publication
(10) Pub. No.: US 2003/0117063 A1
(43) Pub. Date: Jun. 26, 2003

(54) Image display apparatus, method for disassembling image display apparatus and method for manufacturing image display apparatus

(76) Inventor: Hisao Tajima, Kanagawa (JP)

Correspondence Address: FITZPATRICK CELLA HARPER & SCINTO, 30 ROCKEFELLER PLAZA, NEW YORK, NY, 10112, US

(21) Appl. No.: 10/307,989

(22) Filed: Dec. 3, 2002

(30) Foreign Application Priority Data
Dec. 25, 2001 (JP) 391644/2001
Nov. 21, 2002 (JP) 337995/2002

(51) Int. Cl. H01J 9/00; H01J 9/24

(52) U.S. Cl. 313/495; 445/24

(57) ABSTRACT

An image display apparatus includes a display section and a supporting structure for supporting the display section. The supporting structure is constructed by combining a plurality of members adhered to the display section, with combining members.

### BACKGROUND OF THE INVENTION

1. Field of the Invention

The present invention relates to an image display apparatus, a method for disassembling an image display apparatus and a method for manufacturing an image display apparatus.

2. Related Background Art

A thin flat type image display apparatus is used as a television or a terminal of a computer, an advertising medium, an indicator and the like. The thin flat type image display apparatus includes a display apparatus using an electron-emitting device, a display apparatus using a plasma discharge, a display apparatus using liquid crystal, a display apparatus using a fluorescent character display tube, and the like.

The construction of a display apparatus using, for example, a plasma discharge in which the back face of a display section is fixed to a frame with double-faced tapes is known.

Japanese Patent Application Laid-Open No. 11-272182 discloses the construction in which a plasma display panel (PDP) and a plate-like frame are adhered to each other with adhesive agent disposed with a space between the agents, and the construction in which a PDP and a soaking plate are adhered to each other with belt-like double-faced tapes to combine the soaking plate with the plate-like frame.

Japanese Patent Application Laid-Open No. 11-338370 discloses the configuration in which a PDP is fixed to a frame chassis or a panel supporting thin plate with double-faced tapes.

Moreover, the construction disclosed in Japanese Patent Application Laid-Open No. 2000-321989 is known as a supporting structure of an image display apparatus.

### SUMMARY OF THE INVENTION

The present application includes the invention of an image display apparatus having novel construction.

One of the inventions of the image display apparatus according to the present application is constructed as follows.

That is, the invention is an image display apparatus, comprising: a display section for displaying an image; and a supporting body adhered to the display section, the supporting body including two members, each of which is adhered to the display section, the two members being connected to each other with a combining member.

As the combining member, a screw and a rivet can be used. Moreover, if screws are used, the construction in which the screws are directly inserted into the members, the construction in which the two members are fastened with bolts and nuts, and the like can be adopted. Incidentally, each of the two members mentioned here may be one composed of a plurality of members combined to each other. By constructing the supporting body by the combination using the combining member, it is possible to perform the following. That is, the combination with the combining member can be loosened; the combining member can be broken; and the combination can easily be released by removing the combining member. Consequently, a supporting body which can be separated into small members easily can be realized.

Moreover, another of the inventions of the image display apparatus according to the present application is constructed as follows.

That is, the invention is an image display apparatus, comprising: a display section for displaying an image; and a supporting body adhered to the display section, the supporting body including two members, each of which is adhered to the display section severally, the two members being connected to each other with a bar-like member inserted into both of the two members.

Hereupon, as the bar-like member, a screw and a rivet can be used.

Moreover, one of the further inventions of the image display apparatus according to the present application is constructed as follows.

That is, the invention is an image display apparatus, comprising: a display section for displaying an image; and a supporting body adhered to the display section, the supporting body including two members, each of which is adhered to the display section, the two members, each of which is being connected to each other by being fitted in each other.

Incidentally, the construction of each of the inventions described above has an advantage that, when the supporting body is divided into the two members or a plurality of members including the two members, the combination can easily be released at least as to the part being combined. If the supporting body can be divided into the two members or the plural members including the two members, the release of the supporting body from the adhesion with the display section can be performed at every member. Incidentally, it is preferable to adopt the construction in which the members do not interfere with each other when the member is pulled apart from the display section. As that construction, it is preferable to adopt the construction in which the members are located on one surface side of the display section to be adhered to the surface. In such a construction, when a member is released from the combination with the other member, the released member has no part which turns into the opposite surface side. Furthermore, it is preferable to adopt the construction in which each member is adhered to the reverse side of the display section so that the member which has been released from the combination with the other member has no part thereof which goes round to the front side of the display section.

Moreover, one of the inventions of the methods of disassembling an image display apparatus according to the present application is constructed as follows.

That is, the invention is a method for disassembling an image display apparatus including a display section for displaying an image and a supporting body adhered to the display section, the method comprising the steps of: separating the supporting body into at least two parts; and releasing states of the separated parts being adhered to the display section severally.

Hereupon, to separate the supporting body into at least two parts means to change the state of the supporting body in which each part cannot be moved independently as a separated member into the state in which each part can be moved independently.

In the present invention, the step of separating the supporting body and the step of releasing the adhesion of each of the separated parts can be performed in order, or each of the steps can also be performed in a way of overlapping with each other at least in a part of them. Moreover, the step of releasing the states of the separated parts from the adhesion severally can be performed at every separated part in order, or the step can also be performed in a way of making at least a part of each step of releasing the adhesion of each separated part overlap with each other.

Moreover, one of the methods for manufacturing an image display apparatus according to the present application is constructed as follows.

That is the method is a method for manufacturing an image display apparatus including a display section for displaying an image, the method comprising the steps of: separating a supporting body adhered to the display section into at least two parts, the supporting body constituting a structure together with the display section; releasing states of the separated parts being adhered to the display section severally; and assembling the image display apparatus including the display section adhesion of which to the supporting body is released.

Moreover, another of the methods for manufacturing an image display apparatus according to the present application is constructed as follows.

That is, the method is a method for manufacturing an image display apparatus including a display section for displaying an image, the method comprising the steps of: assembling the image display apparatus with predetermined members; separating a supporting body including the members as a part of the supporting body into at least two parts composed of a part to be the members and another part; and releasing states of the separated parts being adhered to the display section severally, wherein the steps of separating the supporting body and releasing the states are performs to a structure composed of the supporting body and the display section as steps of obtaining the members.

Incidentally, the inventions of the image display apparatus, the invention of the method for disassembling an image display apparatus, the inventions of the methods for manufacturing an image display apparatus are specially advantageous in the configuration in which the display sections have substantially flat front faces and back faces. The inventions are especially advantageous in the construction in which the thicknesses of the display sections are severally 20 mm or less. Moreover, the inventions are especially advantageous in the construction in which the main sizes of the display sections are severally 20 inches or more. Furthermore, as the display sections, a display section using an electron-emitting device as its display device, a plasma display panel, a display section using an electroluminescence device as its display device, and a liquid crystal display panel can suitably be adopted.

### BRIEF DESCRIPTION OF THE DRAWINGS

FIG. 1 is a longitudinal section of an image display apparatus representing the features of a first embodiment of the present invention most properly;

FIG. 2 is a perspective view of the main parts of the image display apparatus of FIG. 1 when they are seen from their back sides;

FIG. 3 is a longitudinal section of an image display apparatus representing the features of a second embodiment of the present invention most properly;

FIG. 4 is a perspective view showing the main parts of the image display apparatus of FIG. 3 when they are seen from their back face sides;

FIG. 5 is a perspective view showing a box-like member constituting the supporting body shown in FIG. 4; and

FIG. 6 is a perspective view of an image display apparatus representing the features of a third embodiment of the present invention most properly.

### DESCRIPTION OF THE PREFERRED EMBODIMENTS

In the following, preferred embodiments of the present invention will be described with reference to the attached drawings. Now, a description is given to the principle of the operation of the image display sections of thin plane type image display apparatus of the present embodiments, which will be described in the following. The image display sections use electron-emitting devices. In the embodiments, surface conduction electron-emitting devices are used as the electron-emitting devices. In the operation of the electron-emitting devices, voltages of ten-odd (V) are applied to X-direction wiring and Y-direction wiring which have been selected by electric mounting circuits to emit electrons from the electron-emitting devices on their rear plates. The emitted electrons are accelerated by plus electric potential of ten-odd (kV) supplied from external high voltage power supplies to metal-back films on the vacuum gap sides of face plates. The accelerated electrons collide with phosphor films to generate light emission. Flexible cables connecting the rear plates with the electric mounting circuits are connected with the electric mounting circuits with connectors electromechanically, and are electromechanically connected with the rear plates on the other side with electrode sections (wiring ends) of the X direction wiring and the Y direction wiring which are printed on the rear plates by the use of anisotropic electric conductive films. High voltage cables connecting the metal-back films of the face plates with the high voltage power supply circuits are connected with the high voltage power supply circuits with connectors for high voltages electromechanically, and are electromechanically connected with the face plates on the other side with the metal-back films through high voltage terminals disposed at through holes formed on the rear plates. (As for the details of the operation of the electronemitting devices, see Japanese Patent Application Laid-Open No. 07-235255.)

First Embodiment

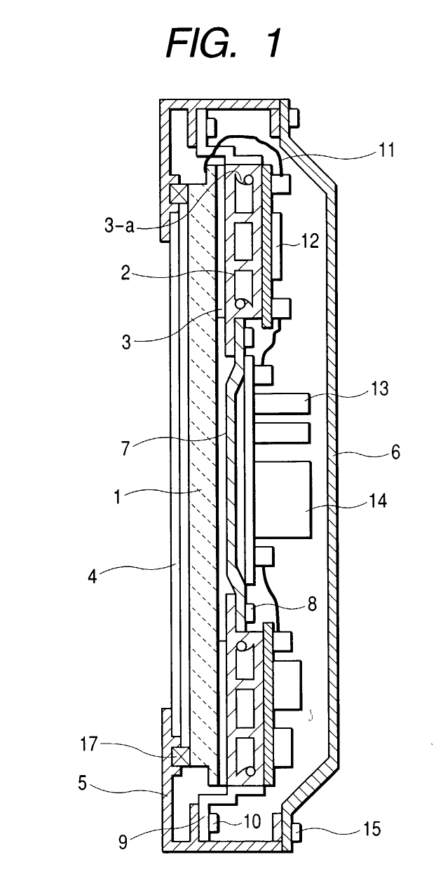

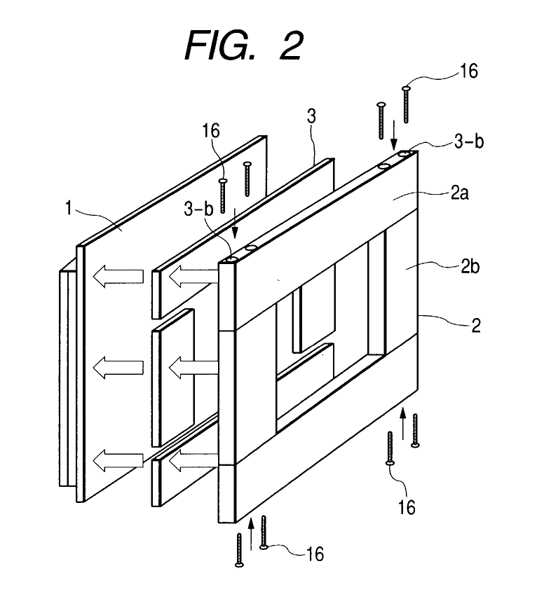

FIG. 1 is a longitudinal section of an image display apparatus representing the features of a first embodiment of the present invention most properly. FIG. 2 is a perspective view of the main parts of the image display apparatus of FIG. 1 when they are seen from their back sides.

The thin plane type image display apparatus shown in FIG. 1 includes a vacuum chamber 1, the inside of which is kept in a vacuum, as an image display section (display panel) for displaying an image. The vacuum chamber 1 is composed of a not shown face plate, a rear plate and a frame member. The face plate has a high voltage region including an RGB phosphor film and a metal-back film, which will be described later, on a glass substrate. The rear plate has the construction in which X direction wiring, Y direction wiring and electron-emitting devices are formed on a glass substrate.

The rear face of the vacuum chamber 1 is fixed on a hollow frame 2 being a supporting body of the present embodiment with the adhesion of a double-faced tape 3 in the shape of a picture frame, which is put between the rear face and the hollow frame 2. The hollow frame 2 is formed in a picture frame shape by cutting a magnesium alloy which has subjected to extrusion into predetermined sizes and by combining the cut pieces with screws 16 being combining means, which will be described later. The hollow frame 2 of the embodiment includes three hollow parts (with two ribs) as the shape of the cutting plane shown in FIG. 1. However, the present invention is not limited to the shape.

The screws 16 are referred in general as a self tap screw and ones for fixing four hollow members cut into predetermined lengths corresponding to long sides and short sides and for combining the hollow members to the picture frame shape, generally that is called self-tapping screws. Penetration parts 3-b (see FIG. 2) are formed by working both the ends of long side members 2a constituting the hollow frame 2 to make it possible to insert the screws 16. Moreover, holes 3-a are formed on both the ends of the short side members 2b constituting the hollow frame 2. The holes 3-a are formed in a body by extrusion processing at wall parts forming the hollow parts of the hollow frame 2. The penetration parts 3-b and the holes 3-a are parts where screws being bar-like members are inserted. Incidentally, the penetration parts 3-b of the long side members 2a and the holes 3-a of the short side members 2b are formed at positions where the screws 16 pass through the insides of the penetration parts 3-b and are fitted in the holes 3-a when the long side members 2a and the short side members 2b, which constitute the hollow frame 2, are combined with each other to the picture frame shape.

In the present embodiment, the supporting body is formed by combining the four members with the screws being combining members. Each of the two long side members 2a and the two short side members 2b, which are four members constituting the supporting body, is severally adhered to vacuum chamber 1 composed of a vacuum chamber 1 constituting the display section with the double-faced tape 3 being an adhesive agent. Each of the four members is formed not to interfere with the movement of separating the vacuum chamber 1 from the long side members 2a and the short side members 2b to release the adhesion when the separation is performed.

A front plate 4 having the function of an optical filter for improving display characteristics, the function of suppressing electromagnetic waves generated from internal electric circuits, and the function of protecting the inside from dust and collisions of bodies is disposed on the side of the face plate, which constitutes the vacuum chamber 1, opposite to the rear plate (on a more front position than that of the face plate). The front plate 4 constitutes the front face of the image display apparatus.

The front plate 4 is attached to a front cover (also called as a face cover) 5 covering the edge of the front face and the side faces of the vacuum chamber 1. The front cover 5 protects the image display section and an electric circuit section, which will be described later, from dust and humidity, and the front cover 5 has the function of improving the external appearance of the image display apparatus. The front cover 5 is formed into a picture frame shape by cutting a magnesium alloy which has electrical conductivity and has been subjected to extrusion into predetermined sizes. A projection forming a groove section or a groove is located on the outer periphery of the front plate 4 on the inside side face of the front cover 5. A seal member 17 is fitted into the groove section. The surface of the end of the seal member 17 which is exposed from the groove section touches closely to the surface of the face plate of the vacuum chamber 1.

A supporting fitting 9 for supporting the front cover 5 is provided at the peripheral part of the hollow frame 2. By combining the supporting fitting 9 with the front cover 5 with screws 10, the front cover 5 is supported by the hollow frame 2.

A back cover 6 (also called as a rear cover) covering the back face side of the image display apparatus is combined with the front cover 5 with screws 15. The screws 15 are disposed to be dispersed at a plurality of positions around the periphery of the housing of the image display apparatus. The back cover 6 is constructed to be able to prevent the invasion of dust and alien substances into the inside of the image display apparatus. Moreover, the back cover 6 has a construction easy to put on and take off with the screws 15 at the time of maintenance. The back cover 6 is formed by the press processing of a magnesium alloy having rigidity.

A plate-like member 7 is combined with the hollow frame 2 in the picture frame shape with screws 8. The plate-like member 7 is disposed at a position where the plate-like member 7 covers the opening at the center of the hollow frame 2. The screws 8 are disposed at a plurality of positions around the periphery of the plate-like member 7. The plate-like member 7 is formed by the press working of, for example, magnesium alloy being an electromagnetic shielding member into a necessary shape. In the present embodiment, a plate member having the thickness of 1.5 mm is used.

On the plate-like member 7 (on the surface of the rear face side of the display apparatus), a signal processing circuit 13 having the functions of converting an analog signal into a digital signal and of controlling an electric circuit system, and a power supply unit 14 for generating a constant direct-current voltage necessary for each electric circuit are mounted.

On the hollow frame 2 (on the surface of the rear face side of the display apparatus), a Y direction driver circuit 12 for generating an electric drive signal for image display (a pulse width modulation signal for performing selective driving), an X direction driver circuit for outputting an electric drive signal (scanning signal) for image display from the signal processing circuit 13, a signal inputting circuit having the functions of inputting various signals (such as an NTSC signal, a video signal, a personal computer signal and the like) from the outside and of cutting off unnecessary signals, and the like are mounted.

The Y direction driver circuit 12 is electrically connected with the rear plate of the vacuum chamber 1 with a flexible cable 11. The flexible cable 11 is connected with the Y direction driver circuit 12 with a drawable connector, and is connected with an electrode pattern formed on the rear plate with an anisotropic electrically conductive tape (not shown) on the other rear plate side.

Next, a description will be given to the characteristic internal structures of the present embodiment.

In the thin plane type image display apparatus of the present embodiment, the members for supporting the vacuum chamber 1 have rigidity for protecting the vacuum chamber 1 from vibrations and impacts from the outside. Moreover, the structure of the housing of the image display apparatus is realized to be thin in the thickness from the front face to the back face of the housing. The hollow frame 2 formed in the picture frame shape mainly contributes to the rigidity in the embodiment. Moreover, the signal processing circuit 13 and the power supply circuit 14, both having a certain measure of thickness, are mounted on the plate-like member 7 having a thickness thinner than that of the hollow frame 2 to realize the thin structure as a whole.

Furthermore, a double-faced tape 3 having the structure made by laminating an acrylic pressure sensitive adhesive on both faces of an acrylic or olefinic substrate is used as the double-faced tape 3 for adhering the hollow frame 2 to the rear plate of the vacuum chamber 1. The double-faced tape 3 has a strong adhesive strength and is capable of adhering the vacuum chamber 1 being the display section to the supporting body strongly to support the display section surely. Moreover, a double-faced tape having a thickness within a range from 0.6 mm to 1.2 mm can preferably be adopted as the double-faced tape 3. By having such a thickness, the double-faced tape 3 can sufficiently absorb the distortion of the vacuum chamber 1 and the hollow frame 2.

Next, a method for separating (disassembling) the vacuum chamber 1 in the present embodiment will be described.

First, the plate-like member 7 attached to the hollow frame 2 is removed by taking off the screws 8. Next, the screws 16 fixing the hollow frame 2 in the picture frame state are taken off. Thereby, the four members constituting the hollow frame 2 being the supporting body are in the state in which each of the four members can independently be moved. Next, a cutter having a thin blade (not shown) is inserted into the gap between the front face of the hollow member 2 and the double-faced tape 3 from the outer periphery side of one of a pair of the short side members 2b constituting the hollow frame 2 so as to peel off the double-faced tape 3, and the cutter is moved. Next, a wedge-like tool (not shown) is inserted into a part where the double-faced tape 3 is peeled off to tear off the short side member 2b of the hollow frame 2 from the vacuum chamber 1 by utilizing the principle of a lever and fulcrum. In accordance with the gist mentioned above, the other short side member 2b and the two long side members 2a of the hollow frame 2 are also separated (disassembled) from the vacuum chamber 1 in the similar way to end the operations.

In the present embodiment, hollow members are used as each member constituting the hollow frame 2 supporting the vacuum chamber 1. It is possible to perform mass production working of the hollow members by preparing an extrusion die having a diameter of about 150 mm. It is also possible to mass-produce the outside dimension of the plate-like member 7 being the other member supporting the vacuum chamber 1 with a small press die in the size of about 700 mm×380 mm. A display section made by combining a rectangular rear plate and a rectangular face plate is used as the display section in the present embodiment. The length of a diagonal line of the display section is 40 inches. The image display apparatus according to the invention of the present application has an advantage capable of disassembling it easily though it has a large screen. In particular, the invention of the present application can specially be adopted to an image display apparatus having a main size (the length of a diagonal line in case of a square display section, the length of the long axis in case of an elliptical display section, and the diameter in case of a circular display section) equal to or more than 20 inches, the disassembly of which have conventionally been difficult.

Incidentally, although magnesium alloy is used as the materials of the hollow frame 2, the plate-like member 7, the front cover 5 and the back cover 6 of the present invention, the similar advantages can be obtained by using aluminium alloy. Moreover, even if the number of ribs in the hollow parts of the hollow frame 2 is one instead of two, such a hollow frame 2 can deal with the rigidity.

As described above, in the first embodiment, the following characteristic components are adopted.

(1) The means for supporting the vacuum chamber 1 is composed of the hollow frame 2 and the plate-like member 7 thinner than the hollow frame 2. Thereby, the rigidity is secured by the hollow frame 2 formed in a picture frame shape, and the electric circuits having a certain measure of thickness are mounted on the plate-like member 7 to make the thickness of the housing to be thin.

(2) A double-faced tape made by laminating an acrylic pressure sensitive adhesive on both surfaces of an acrylic or olefinic substrate having a thickness within a range from 0.6 mm to 1.2 mm is adopted as the means for fixing the vacuum chamber 1 to the hollow frame 2.

(3) The hollow frame 2 being the supporting body of the vacuum chamber 1 is made as follows. A hollow member obtained by extrusion is cut into pieces having predetermined lengths. The thus obtained two long side members and two short side members are combined to each other into a picture frame shape with screws. A plate-like member made by press working is disposed at the center of the picture frame shape to be fixed thereto with screws.

By means of the image display apparatus having such a form, the following advantages can be obtained.

(1) By the combination of the hollow frame 2 and the plate-like member 7, the thickness of the housing of the image display apparatus becomes thin, and moreover the weight saving thereof can be achieved.

(2) The distortion of the parts of the vacuum chamber 1 and the hollow frame 2 can be absorbed by the double-faced tape 3 put between them, and the drop out of the vacuum chamber 1 can be prevented thereby, which improves the reliability of the image display apparatus.

(3) Because the supporting body of the vacuum chamber 1 can be separated into four hollow members adhered to the display section severally, the separation of the supporting body from the vacuum chamber 1 can be performed by simple operations. Consequently, the charm of the image display apparatus is increased as a commodity capable of being accommodated in accordance with environments. Moreover, although the plate-like member is also combined with the supporting body, the combination is also releasable easily. Consequently, the plate-like member can easily be taken off before the release of the supporting body from the adhesion to the display section.

(4) Because the hollow frame 2 and the plate-like member 7 can be made by the use of cheaper dies in comparison with ordinary ones for the screen size. Consequently, the initial mass-production cost of the image display apparatus can be decreased and the costs of products can also be suppressed to be cheap.

Second Embodiment

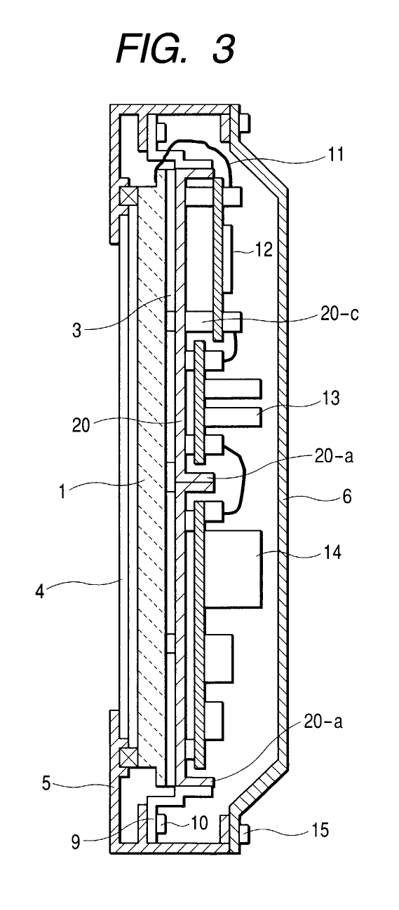

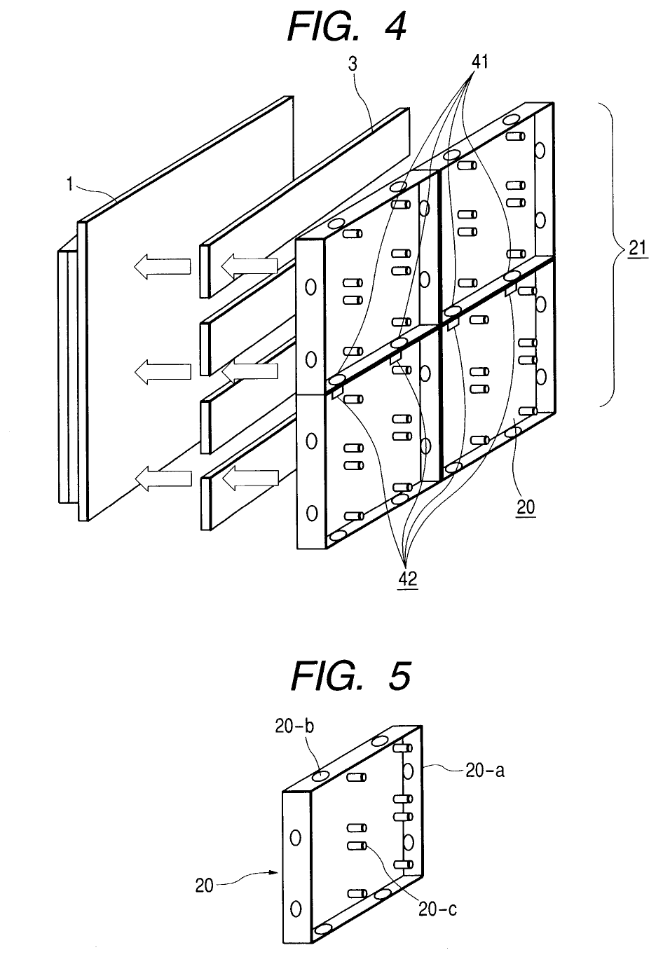

In the following, a second embodiment will be described with reference to the drawings. The similar members as those in the first embodiment are designated by the same reference numerals as those of the first embodiment in the drawings, and the descriptions of the similar members are omitted. FIG. 3 is a longitudinal section of an image display apparatus representing the features of the second embodiment of the present invention most properly. FIG. 4 is a perspective view showing the main parts of the image display apparatus of FIG. 3 when they are seen from their back face side. FIG. 5 is a perspective view showing a box-like member constituting the supporting body shown in FIG. 4.

In the present embodiment, as shown in FIGS. 3-5, a supporting body 21 supporting the back face of the vacuum chamber 1 with double-faced tapes 3 put between them is in a structure of combining four box-like members 20. The double-faced tapes 3 are disposed in parallel with each other on the back face of the vacuum chamber 1.

The peripheral parts of the box-like members 20 are formed to be ribs 20-a formed by bending aluminium alloy plates by press working. Tapped holes 20-b are formed on the ribs 20-a by pierce working. The supporting body 21 is formed by combining the four box-like members 20 in such a way that the ribs 20-a adjoin to each other,,and by fastening each box-like members 20 with screws 41 and nuts 42 by making use of the tapped holes 20-b on the ribs 20-a of each box-like members 20.

Each of the box-like members 20 is formed not to interfere with the movement of separation when the vacuum chamber 1 is separated from the box-like members 20 to release the adhesion of them.

A plurality of bosses 20-c is welded on the flats of the box-like members 20. Internal threads (not shown) are worked at the points of the bosses 20-c. Electric circuits such as the Y direction driver circuit 12 and the like are fitted on the bosses 20-c with screws (not shown). The heights of the bosses 20-c are changed in accordance with the thicknesses of the electric circuits to be fitted in the direction from the front to the back of the housing.

Next, a description will be given to the characteristic structures of the present embodiment.

In the thin plane type image display apparatus of the present embodiment, the members for supporting the vacuum chamber 1 have rigidity for protecting the vacuum chamber 1 from vibrations and impacts from the outside. In the embodiment, as to the rigidity, the supporting body 21 constructed to be a rectangular parallelepiped by combining the four box-like members 20 having the ribs 20-a on their peripheries mainly contributes to the rigidity. By putting the signal processing circuit 13 and the power supply unit 14, both having a certain measure of thickness (height), in the recesses of the box-like members 20 to fix them to the bosses 20-c with screws (not shown), the structure having a thin thickness as a whole can be realized.

Furthermore, it is suitable to use a double-faced tape made by laminating an acrylic pressure sensitive adhesive on both faces of an acrylic or olefinic substrate as the double-faced tape 3 for adhering the supporting body 21 to the rear plate of the vacuum chamber 1. By using the double-faced tape 3, the vacuum chamber 1 can be supported with a large adhesive strength. It is suitable that the double-faced tape 3 has a thickness within a range from 0.6 mm to 1.2 mm. By using the double-faced tape 3, the distortion of the vacuum chamber 1 and the supporting body 21 can be absorbed sufficiently.

Next, a method for separating (disassembling) the vacuum chamber 1 in the present embodiment will be described.

First, the screws 41 and the nuts 42 fastening the four box-like members 20 and nut 42 being members constituting the supporting body 21 are taken off. Next, a cutter having a thin blade (not shown) is inserted into a gap between any one side of any one of the four box-like members 20 which constitutes the outer periphery of the supporting body 21 and the double-faced tape 3 so as to peel off the double-faced tape 3, and the cutter is moved. Next, a wedge-like tool (not shown) is inserted into the part where the double-faced tape 3 is peeled off to tear off the side of the box-like member 20 from the vacuum chamber 1 by utilizing the principle of a lever and fulcrum. Thereby, the box-like member 20 is removed. In accordance with the gist mentioned above, the other three box-like members 20 are also separated (disassembled) from the vacuum chamber 1 one by one by the same method to end the operations.

Moreover, it is possible to perform the mass production of the outside dimension of each box-like member 20 constituting the supporting body 21 supporting the vacuum chamber 1 with a small press die in the size of about 440 mm×280 mm, though the vacuum chamber 1 has the screen size of 40 inches.

Incidentally, although aluminium alloy is used as the materials of the box-like members 20 of the present embodiment, the similar advantages can be obtained by using magnesium alloy. Moreover, screws are used as the members for fastening the box-like members 20 in the embodiment. As a combining member, for example, a fastening member enclosing the outer periphery (the outer periphery composed of the ribs 20-a of the outer periphery) of the supporting body 21 can be used. To put it concretely, a configuration for fastening the outer periphery with a continuous plate (e.g. a tension band to be used in a cathoderay tube (CRT)) can be adopted. Moreover, although the configuration shown in FIG. 4 adopts the configuration in which a box-like member 20 is combined with an adjoining box-like member 20 with screws 41 and nuts 42, the configuration in which box-like members 20 are combined by being fitted in each other by means of fitting protrusions formed on one box-like member 20 and fitting holes formed on an adjoining box-like member 20 can also be adopted. In this case, because it is possible to release the combination by pushing the fitting protrusions from the fitting hole side, it becomes possible to release the combination easily. It is preferable to form the fitting structure at a plurality of positions for making combination strength strong sufficiently. If a jig for pushing the fitting protrusions from the fitting hole side is used, the fitting can suitably be released. In particular, if a plurality of fitting positions exists, a jig capable of releasing the fitting at a plurality of fitting positions at the same time would be used suitably.

As described above, in the second embodiment, the following characteristic components are adopted.

(1) As the means for supporting the vacuum chamber 1, the supporting body 21 in the shape of a rectangular parallelepiped constructed by combining the four box-like members 20 having the ribs 20-a on their peripheries is adopted. Moreover, the electric circuits are put in the recesses of the box-like members 20.

(2) A double-faced tape which has the construction made by laminating an acrylic pressure sensitive adhesive on both surfaces of an acrylic or olefinic substrate and has a thickness within a range from 0.6 mm to 1.2 mm is adopted for adhering the supporting body 21 to the vacuum chamber 1.

By means of the second embodiment having such construction, the following advantages can be obtained.

(1) By the supporting body 21, the vacuum chamber 1 is protected from vibrations and impulses from the outside. Moreover, the thickness of the housing can be made to be thin. Thereby, the properties as a commodity are improved.

(2) The distortion of the parts of the vacuum chamber 1 and the supporting body 21 can be absorbed by the double-faced tape 3 put between them, and thereby the drop out of the vacuum chamber 1 can be prevented, which improves the reliability of the image display apparatus.

(3) The separation of the vacuum chamber 1 from the means for supporting the vacuum chamber 1 (the supporting body 21) can be performed by simple operations, and the charm of the image display apparatus is increased as a commodity capable of being accommodated in accordance with environments.

(4) Because each box-like member 20 constituting the supporting body 21 supporting the vacuum chamber 1 can be made by the use of cheaper dies, the initial cost of mass-production can be decreased, and the costs of manufactured goods can also be suppressed to be cheap.

Third Embodiment

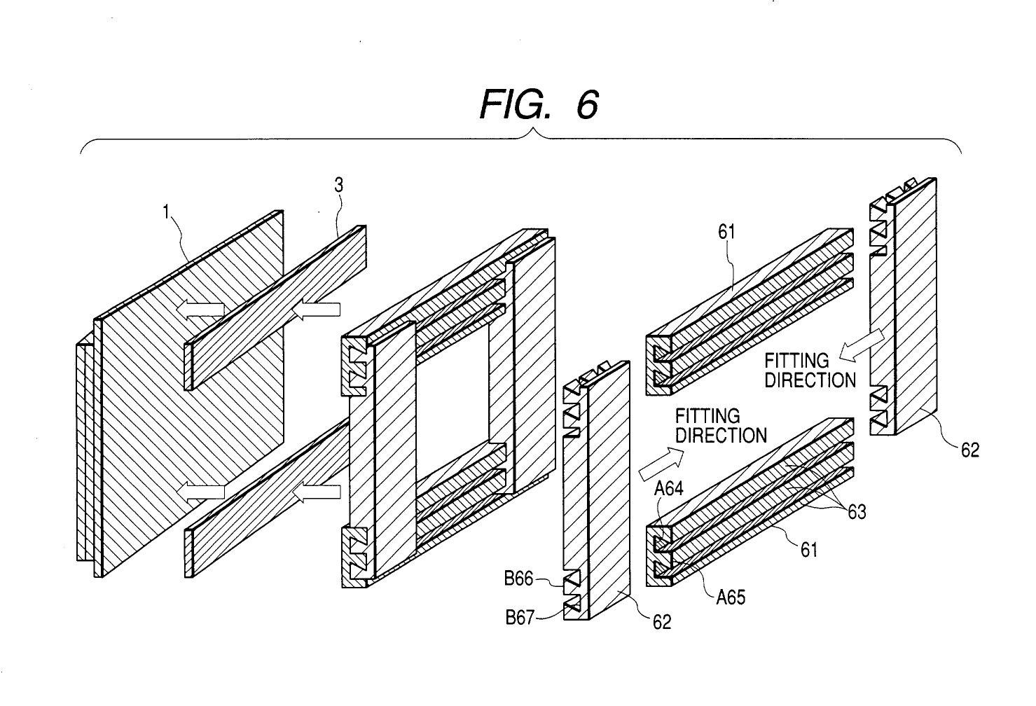

In the embodiment described below, an example in which members constituting a supporting body are combined to each other by being fitted in each other will be described. The construction of the supporting body in the present embodiment will be described with reference to FIG. 6.

A reference numeral 61 designates a long side member being a member constituting the supporting body. The supporting body includes two long side members 61, which are members adhered to the vacuum chamber 1 with double-faced tapes 3. The long side members 61 have severally a structure including three rib portions 63 as a structure for heightening the rigidity of the long side members 61 themselves sufficiently. The protruding parts of the rib structure are protrusions A65. The recesses adjoining to the protruding parts are recesses A64. The supporting body of the present embodiment further includes two short side members 62. All of the long side members 61 and the short side members 62 have been obtained by cutting the same member having the rib portions which have been formed by extrusion into pieces having predetermined lengths. The short side members 62 have rib portions which have been formed by the extrusion like the long side members 61, and have protrusions and recesses along the extended direction of the ribs. The short side members 62 further include protrusions B66 and recesses B67, both being formed by machine working.

The supporting body of the present embodiment is composed of the two long side members 61 and the two short side members 62, both being fitted in each other in the fitting directions shown in FIG. 6. The protrusions A65 of the long side members 61 are fitted into the recesses B67 of the short side members 62 in the manner of adhering closely to the recesses B67. The protrusions B66 of the short side members 62 are fitted into the recesses A64 of the long side members 61 in the manner of adhering closely to the recesses A64. The structure of the supporting body can be said to be the structure in which the long side members 61 and the short side members 62 are combined to each other by being fitted in each other. Moreover, the structure can also be said to be the structure in which the two long side members 61 are combined to each other by means of the short side members 62 being combining members for performing the fitting. Moreover, the structure can further be said to be the structure in which a member is formed by the combination of a long side member 61 and a short side member 62 and two of the member is combined by fitting to form the supporting body.

The other parts of the structure of the image display apparatus of the present embodiment are the same as those of the first embodiment except the part of the frame-shaped supporting body.

When the image display apparatus having such construction is disassembled, first the front cover, the back cover, the drive circuit and the like are removed. After that, the short side members 62 are pulled out from the long side members 61. After that, the two long side members 61, each adhering to the vacuum chamber 1, are peeled off from the vacuum chamber 1.

The first to the third embodiments mentioned above are the embodiments capable of solving the following problems.

(1) It is difficult to separate (disassemble) the supporting bodies having rigidity and the vacuum chambers without damaging them at the time of the recycle of the image display apparatus. If they are broken at the time of the separation, they cannot be reclaimed afterward.

(2) The initial cost of a die casting mold for manufacturing the supporting body is high, and consequently it is not suitable for large item small scale production (the unit cost of a product is heightened). Moreover, a making machine becomes larger in accordance with the increase of screen sizes, and the cost of production is also heightened.

In the above, the first to the third embodiments have been exemplified as concrete embodiments, and the construction of the image display apparatus in each of them has been described in detail.

The present application includes not only the inventions of the image display apparatus, but also the inventions of the disassembling methods. The disassembling methods of the above-mentioned image display apparatus have been described in regard to each embodiment. The inventions of the disassembling methods in the preset application are not only the methods for disassembling the image display apparatus according to each of the embodiments, but also can be applied to image display apparatus having various kinds of construction as their disassembling methods.

That is, in each of the above-mentioned embodiments, the constructions adopting the supporting bodies which make it easy to be disassembled to each member by adopting the fitting structure for combining the members, or the like have been described as the constructions of the image display apparatus according to the present application. The inventions of disassembling methods according to the present application are the inventions in each of which the adhesion of each of a plurality of members adhering to the display section is released severally. With regard to the inventions of the disassembling methods, for example, the construction in which the adhesion of each member to the display section is severally released by separating the supporting body into a plurality of members by cutting it can also be adopted. Moreover, the process of separating the supporting body into the plural members and the process of releasing the adhesion of each member to the display section severally may be performed in the way of overlapping with each other at least in a part of them.

Moreover, the present application includes the invention of a method for manufacturing an image display apparatus by the use of at least a part of the members constituting the display section or the supporting body, the members being obtained by the aforesaid disassembling methods.

An example of manufacturing method of an image display apparatus will be described in the following.

The example is one for manufacturing an image display apparatus by the use of the display section obtained by the above-mentioned disassembling method.

The display section which has been released from the supporting body which has adhered the display section by any one of the disassembling methods is obtained. The display section is used for being assembled to an image display apparatus. To put it concretely, it is possible to assemble the image display apparatus by combining a supporting body equipped with a drive circuit different from one provided on the supporting body before the disassembling as the supporting body different from the adhering one before the disassembling with the display section obtained by the disassembling.

Moreover, an image display apparatus can be manufactured by the use of the members obtained by the above-mentioned disassembling methods except the display section. First, the supporting body and the display section are separated by the above-mentioned disassembling methods. The image display apparatus can be manufactured by combining at least a part of the members constituting the supporting body with a display section different from the display section before the disassembling. The construction made by combining a supporting body, being assembled by combining each member separated by the above-mentioned disassembling methods, with a display section different from that before the disassembling can suitably be adopted.

What is claimed is:

1. An image display apparatus, comprising:
a display section for displaying an image; and
a supporting body adhered to said display section, said supporting body including two members, each of which is adhered to said display section, said two members being connected to each other with a combining member.

2. An image display apparatus, comprising:
a display section for displaying an image; and
a supporting body adhered to said display section, said supporting body including two members, each of which is adhered to said display section, said two members being connected to each other with a bar-like member inserted into both of said two members.

3. An image display apparatus, comprising:
a display section for displaying an image; and
a supporting body adhered to said display section, said supporting body including two members, each of which is adhered to said display section, said two members being connected to each other by being fitted in each other.

4. A method for disassembling an image display apparatus including a display section for displaying an image and a supporting body adhered to said display section, said method comprising the steps of:
separating said supporting body into at least two parts; and
releasing states of said separated parts being adhered to said display section,.

5. A method for manufacturing an image display apparatus including a display section for displaying an image, said method comprising the steps of:
separating a supporting body adhered to said display section into at least two parts, said supporting body constituting a structure together with said display section;
releasing states of said separated parts each being adhered to said display section; and
assembling said image display apparatus including said display section adhesion of which to said supporting body is released.

6. A method for manufacturing an image display apparatus including a display section for displaying an image, said method comprising the steps of:
assembling said image display apparatus with predetermined members;
separating a supporting body including said members as a part of said supporting body into at least two parts composed of a part to be said members and another part; and
releasing states of said separated parts being adhered to said display section,
wherein said steps of separating said supporting body and releasing said states are performs to a structure composed of said supporting body and said display section as steps of obtaining said members.
